(19) United States
(12) Patent Application Publication
(10) Pub. No.: US 2007/0116912 A1
(43) Pub. Date: May 24, 2007

(54) Resin composition for a liquid container and a liquid container composed thereof

(75) Inventors: Satoshi Takahashi, Tokyo (JP); Hisami Tamano, Yokohama-shi (JP); Takeshi Kobayashi, Yokohama-shi (JP); Hideyuki Ikoma, Yokohama-shi (JP); Kenichiro Tachi, Yokohama-shi (JP)

Correspondence Address: OLIFF & BERRIDGE, PLC, P.O. BOX 19928, ALEXANDRIA, VA, 22320, US

(73) Assignee: MITSUBISHI PENCIL CO., LTD., YOKOHAMA-SHI (JP)

(21) Appl. No.: 11/602,393

(22) Filed: Nov. 21, 2006

(30) Foreign Application Priority Data
Nov. 22, 2005 (JP) 2005-337546
Nov. 20, 2006 (JP) 2006-312983

(51) Int. Cl. B32B 27/08

(52) U.S. Cl. 428/35.7

(57) ABSTRACT

The present invention provides a resin composition for a liquid container that is good in a gas barrier property, transparency, and water and/or repellency. The resin composition of the present invention comprises: (a) 100 parts by weight of a polyolefin resin; (b) 3 to 40 parts by weight of at least one resin selected from the group consisting of hydrogenated terpene resins, petroleum resins, and hydrogenated petroleum resins; and (c) 0.03 to 5 parts by weight of at least one component selected from the group consisting of silicone oils, fluorosurfactants, and paraffin oils, with their viscosities being 20 to 3000 cSt at 25° C., as determined according to JIS Z 8803.

### CROSS REFERENCE

This application claims benefits of Japanese Patent Application No. 2005-337546 filed on Nov. 22, 2005 and Japanese Patent Application No. 2006-312983 filed on Nov. 20, 2006, the contents of which are hereby incorporated by reference.

### FIELD OF THE INVENTION

The present invention relates to a resin composition for a liquid container having a good gas barrier property, transparency, water and/or oil repellency and to a liquid container composed thereof.

### BACKGROUND OF THE INVENTION

Conventionally, as a container for holding an aqueous liquid, an oily liquid, or a gel-like liquid, such as ink for ballpoint pens or cosmetics, use has been made of various types of containers composed of polyolefin resins such as polypropylene. These containers are desired to have transparency which allows one to confirm a remaining volume of the content from outside, and a good gas barrier property, which is to avoid degradation of the content caused by permeation of oxygen or steam, or evaporation of the content. A low gas barrier property causes problems such as reduction in an amount of the content with time as well as increase in viscosity, oxidation, solidification, and increase in inner pressure, which all worsen the product's quality and longevity.

Polyolefin resins such as polypropylene are prefered in terms of chemical stability, solvent resistance, economics, and productivity, but it is difficult to make the polyolefin resins to have both a good transparency and a good gas barrier property. Resins with a good transparency have a poor gas barrier property, while resins with a good gas barrier property have a poor transparency due to their high crystallinity.

These containers are also desired to have water and/or oil repellency. If water and/or oil repellency is bad, the content adheres to an inner wall of the container, appearance is bad and the remaining volume of the content is difficult to be confirmed from outside. This is particularly notable when the content contains a dark colored material. Flowable cosmetics move frequently in a container when they are carried around and shaken: in a case of a nail enamel, if the enamel liquid adheres to threaded parts of the cap and the container, the liquid solidifies, so that the cap cannot be opened. Accordingly, water and/or oil repellency is highly desired. Furthermore, if the content remains adhered on the inner wall of the container, it causes environmental pollution in disposing the container.

To provide resins with a high gas barrier property, for instance, Japanese Patent Application Laid-Open Nos. 2004-25446 and 11-239515 disclose a container member having multi-layer structure comprising a resin layer with a good oxygen barrier property. However, the multi-layer structure has a problem of exfoliation of layers and reduction in transparency.

A wrapping film is also known from Japanese Patent Application Laid-Open No. 2004-167977, which is provided with a gas barrier property by coating one side of a plastic film with an inorganic material. However, it has problems, such as exfoliation of the coating layer, occurrence of cracks, reduction in transparency, and increase in cost accompanied by the increased laminating steps.

Meanwhile, Japanese Patent No. 3201977 discloses a process comprising coating an inner wall of an ink holding member composed of a thermoplastic resin, with a silicone oil in order to increase its water and/or oil repellency. However, such coating cannot be said to be beneficial in terms of long-lasting effect and/or preservation. A multi-layered container with an inner wall composed of a resin composition containing silicone oil is also known from Japanese Patent Application Laid-Open No. 11-240118.

However, the silicone oil kneaded with a polyolefin resin, such as polypropylene, worsens a gas barrier property.

### SUMMARY OF THE INVENTION

An object of the present invention is to provide a resin composition having a good gas barrier property, transparency, and water and/or oil repellency and a liquid container composed thereof, which are free of the above-described problems.

The present inventors have found that it is possible to obtain a resin composition having the above-described good properties by blending a polyolefin resin with a hydrogenated terpene resin, a petroleum resin and/or a hydrogenated petroleum resin and with a silicone oil, a fluorosurfactant and/or a paraffin oil in specific proportions.

Thus, the present invention is a resin composition for a liquid container, wherein the composition comprises:
(a) 100 parts by weight of a polyolefin resin;
(b) 3 to 40 parts by weight of at least one resin selected from the group consisting of hydrogenated terpene resins, petroleum resins, and hydrogenated petroleum resins; and
(c) 0.03 to 5 parts by weight of at least one component selected from the group consisting of silicone oils, fluorosurfactants, and paraffin oils, with their viscosities being 20 to 3000 cSt at 25° C., as determined according to JIS Z 8803.

### DESCRIPTION OF THE PREFERRED EMBODIMENTS

According to a preferred embodiment of the present invention, resin (a) is at least one resin selected from the group consisting of low density polyethylenes, linear low density polyethylenes, medium density polyethylenes, high density polyethylenes, and polypropylenes.

According to another preferred embodiment, resin (a) is at least one resin selected from the group consisting of isotactic propylene homopolymers and copolymers of propylene with ethylene and/or α-olefins.

The present invention also provides a molded container composed of the aforesaid resin composition, particularly a an ink container for writing instruments and a cosmetic container.

The present invention further provides a writing instrument having the aforesaid ink container for writing instruments and a cosmetic contained in the aforesaid cosmetic container.

### EFFECTS OF THE INVENTION

The resin composition of the present invention has a good gas barrier property, transparency, and water and/or oil repellency and, therefore, useful as a material for a liquid container member of writing instruments, such as ballpoint pens or cosmetic products.

### DETAILED DESCRIPTION OF THE INVENTION

Each component of the resin composition of the present invention will be described in the following.

Resin (a): Polyolefin Resins

Resin (a) encompasses homopolymers of olefins, such as ethylene and propylene, and copolymers thereof. Specifically, mention may be made of low density polyethylenes, linear low density polyethylenes, medium density polyethylenes, high density polyethylenes and polypropylenes. Preferred in terms of gas barrier property is polypropylenes, particularly, isotatctic polypropylene homopolymers and block copolymers of propylene with ethylene and/or α-olefins, such as 1-butene, 1-pentene, 1-hexene, 1-heptene, and 1-octene.

The melting point of resin (a), as determined by DSC, is preferably higher than 150° C. for better rigidness and a gas barrier property. Preferably the upper limit is 165° C. If the melting point is higher than the aforesaid upper limit, transparency is insufficient.

Here, the melting point as determined by DSC is a peak top melting point obtained by determination with a differential scan calorimeter (DSC). Specifically, 10 mg of a sample is maintained at a temperature of 190° C. for 5 minutes, cooled to a temperature of −10° C. at a cooling rate of 10° C./minute to crystallize, maintained at a temperature of −10° C. for 5 minutes, and heated up to a temperature of 200° C. at a heating rate of 10° C./minute with scanning to determine a peak top melting point.

Resin (a) preferably has a flexural modulus according to JIS K 7171 of 500 MPa or higher. If it is less than 500 MPa, rigidity is insufficient.

Resin (b): Hydrogenated Terpene Resins, Petroleum Resins, and Hydrogenated Petroleum Resins

Resin (b) provides the resin compositions with transparency and a gas barrier property. The present composition also comprises component (c) to improve water and/or oil repellency, whereas resin (b) also has an effect of preventing the gas barrier property from worsening due to the addition of component (c).

Resin (b-1): Hydrogenated Terpene Resins

Examples of the resin (b-1) include hydrogenated derivatives of terpene resins such as polymerized α-pinene or β-pinene, terpene phenolic resins obtained by reacting terpene with phenol, and aromatic-modified terpene resins imparted with polarity by styrene or the like.

It is preferred in terms of tackiness, rigidity, modulus, and molding property, particularly mold-release property, that resin (b-1) has a softening point higher than 120° C.

The hydrogenated terpene resins may be obtained by hydrogenating terpene resins in a method known to a person with ordinary skill.

Commercially available resins are also used as resin (b-1), for instance, Clearlon, ex Yasuhara Chemical.

Resin (b-2): Petroleum Resins and Hydrogenated Petroleum Resins

Petroleum resins mean resin-like materials, obtained in various processes in the petroleum refining industries and petrochemical industries, or copolymer resins obtained by copolymerizing unsaturated hydrocarbons from the aforesaid processes, particularly naphtha cracking. Mention may be made of, for instance, aromatic petroleum resins derived mainly from C5 fraction, copolymer petroleum resins thereof, and alicyclic petroleum resins. Preferred are aliphatic petroleum resins, the aromatic petroleum resins, the copolymer petroleum resins, and the alicyclic petroleum resins.

Resin (b-2) may also be hydrogenated derivatives of the aforesaid petroleum resins. The hydrogenated petroleum resins are, preferably, completely hydrogenated. Partially hydrogenated derivatives tend to be poor in heat stability and weather resistance.

The hydrogenated petroleum resins are obtained by hydrogenating, in a conventional method, the aforesaid petroleum resins prepared in a conventional method.

The hydrogenated petroleum resins are particularly preferred for molded articles which require heat resistance. More preferably, use is made of hydrogenated aliphatic petroleum resins, particularly, hydrogenated cyclopentadiene resins.

It is preferred in terms of tackiness, rigidity, modulus, and molding property, particularly mold-release property, that resin (b-2) has a softening point higher than 120° C.

As resin (b) in the present resin composition, use is made of at least one resin selected from the group consisting of the aforesaid hydrogenated terpene resins, petroleum resins, and hydrogenated petroleum resins. Resin (b) may be blended in an amount of 3 to 40 parts by weight, preferably 10 to 30 parts by weight, relative to 100 parts by weight of resin (a). When the amount is greater than the aforesaid upper limit, a resulting molded container is fragile and tacky, and the composition is bad in injection molding property and extrusion molding properties. Water and/or oil repellency also decrease. When the amount is less than the aforesaid lower limit, improvement in the transparency and the gas barrier property are insufficient.

Component (c): Silicone Oils, Fluorosurfactants, and Paraffin Oils

Component (c) provides a resulting resin composition with water and/or oil repellency.

Component (c-1): Silicone Oils

Component (c-1) can provide a resulting resin composition with water and/or oil repellency. Examples of the component (c-1) include dimethylsilicone oils, methylphenylsilicone oils, hydrogen silicone oils, alkyl-modified silicone oils, fluorine-modified silicone oils, polyether-modified silicone oils, alcohol-modified silicone oils, amino-modified silicone oils, epoxy-modified silione oils, epoxy and/or polyether-modified silicone oils, phenol-modified silicone oils, and carboxyl-modified silicone oils. Preferred are dimethylsilicone oils and methylphenylsilicone oils.

It is essential for component (C-1) to have a viscosity of from 20 to 3000 cSt, preferably from 20 to 1000 cSt. When the viscosity of a silicone oil is less than the aforesaid lower limit, the silicone oil is volatile and tends to degrade resin (a), which is unfavorable. When the viscosity is higher than the aforesaid upper limit, component (c-1) less improves the water and/or oil repellency, and further it is difficult to handle, blend and knead the composition in the preparation of the composition.

Component (c-2): Fluorosurfactants

Component (c-2) can provide a resulting resin composition with water and/or oil repellency. Examples of component(c-2) include fluoroalkyl(C2-C10)carboxylic acids, disodium N-perfluorooctanesulfonylglutamate, sodium 3-(fluoroalkyl(C6-C11)oxy)-1-alkyl(C3-C4)sulfonate, sodium 3-(ω-fluoroalkanoyl(C6-C8)-N-ethylamino)-1-propanesulfonate, N-[3-(perfluorooctanesufoneamide)propyl)-N,N-dimethyl-N-carboxymethyleneammonium betaine, fluoroalkyl(C11-C20)carboxylic acids, perfluoroalkyl(C7-C13)carboxylic acids, perfluorooctanesulfonate diethanolamide, lithium perfluoroalkyl(C4-C12)carboxylate, potassium perfluoroalkyl(C4-C12)carboxylate, sodium perfluoroalkyl(C4-C12)carboxylate, N-propyl-N-(2-hydroxyethyl)perfluorooctanesulfoneamide, perfluoroalkyl(C6-C10)sulfoneamidepropyltrimethylammonium salt, perfluoroalkyl(C6-C10)-N-ethylsulfonylglycine salt, phosphoric acid bis(N-perfluoroctylsulfonyl-N-ethylaminoethyl), and ethyl monoperfluoroalkyl(C6-C10)ethylphosphate.

Component (c-3): Paraffin Oils

Component (c-3) can provide a resulting composition with water repellency. Examples of component (c-3) include paraffin-based compounds having 4 to 155 carbon atoms, preferably 4 to 50 carbon atoms, for instance, n-paraffins (linear saturated hydrocarbons) such as butane, pentane, hexane, heptane, octane, nonane, decane, undecane, dodecane, tetradecane, pentadecane, hexadecane, heptadecane, octadecane, nonadecane, eicosane, heneicosane, docosane, tricosane, tetracosane, pentacosane, hexacosane, heptacosane, octacosane, nonacosane, triacontane, hentriacontane, dotriacontane, pentatriacontane, hexacontane, and heptacontane; and isoparaffins (branched saturated hydrocarbon), such as isobutane, isopentane, neopentane, isohexane, isopentane, neohexane, 2,3-dimethylbutane, 2-methylhexane, 3-methylhexane, 3-ethylpentane, 2,2-dimethylpentane, 2,3-dimethylpentane, 2,4-dimethylpentane, 3,3-dimethylpentane, 2,2,3-trimethylbutane, 3-methylheptane, 2,2-dimethylhexane, 2,3-dimethylhexane, 2,4-dimethylhexane, 2,5-dimethylhexane, 3,4-dimethylhexane, 2,2,3-trimethylpentane, isooctane, 2,3,4-trimethylpentane, 2,3,3-trimethylpentane, 2,3,4-trimethylpentane, isononane, 2-methylnonane, isodecane, isoundecane, isododecane, isotridecane, isotetradecane, isopentadecane, isooctadecane, isononadecane, isoeicosane, and 4-ethyl-5-methyloctane; and derivatives of these saturated hydrocarbons. These paraffins are preferably used as a mixture and preferably liquid at room temperature.

Commercially available paraffin oils which are liquid at room temperature are, for instance, NA solvent, isoparaffin-based hydrocarbon oil ex Nippon Oil and Fats Corporation; PW-90, n-paraffin-based process oil ex Idemitsu Kosan Co., Ltd.; IP-solvent 2835, synthetic isoparaffin hydrocarbon with 99.8 wt % or higher of isoparaffins, ex Idemitsu Petrochemical Co., Ltd.; and neothiozole, n-paraffin-based process oil, ex Sanko Chemical Industry Co., Ltd.

A slight amount of unsaturated hydrocarbons or derivatives thereof may co-exist in paraffin oils. Examples of the unsaturated hydrocarbons include ethylene series hydrocarbons, such as ethylene, propylene, 1-butene, 2-butene, isobutylene, 1-pentene, 2-pentene, 3-methyl-1-butene, 3-methyl-1-butene, 2-methyl-2-butene, 1-hexene, 2,3-dimethyl-2-butene, 1-heptene, 1-octene, 1-nonene, and 1-decene; and acetylene series hydrocarbons such as acetylene, methylacetylene, 1-butyne, 2-butyne, 1-pentyne, 1-hexyne, 1-octyne, 1-nonyne, and 1-decyne.

As component (c) in the resin composition of the present invention, use is made of at least one component selected from the group consisting of the above-described silicone oils, fluorosurfactants, and paraffin oils. Component (c) may be used in an amount of from 0.03 to 5 parts by weight preferably from 0.05 to 3 parts by weight, more preferably from 0.1 to 3 parts by weight, even more preferably from 0.5 to 3 parts by weight, and particularly preferably from 1 to 3 parts by weight, relative to 100 parts by weight of resin (a). When the amount is larger than the aforesaid upper limit, bleed-out occurs and molding properties are worse. Gas barrier property is also worse. When the amount is less than the aforesaid lower limit, water and/or repellency is not sufficiently improved. When component (c) does not contain fluorosurfactant (c-2), that is, component (c) is silicone oil (c-1) and/or paraffin oil (c-3), component (c) is preferably incorporated in an amount of at least 0.1 wt %, relative to 100 parts by weight of resin (a).

Other Components

The resin composition of the present invention may comprise other components such as heat stabilizers; antioxidants; photo stabilizer; ultraviolet ray absorbents; necleating agents; blocking inhibitors; sealability improving agents; release agents such as stearic acid; lubricants such as polyethylene wax; coloring agents; pigments; inorganic fillers such as alumina, talc, potassium carbonate, mica, walastenite, and clay; organic and inorganic blowing agents; and flame retardants such as hydrated metal compounds, red phosphorous, ammonium polyphosphate, antimony, and silicones.

Examples of the antioxidants include phenol-based antioxidants such as 2,6-di-tert-butyl-p-cresol, 2,6-di-tert-butylphenol, 2,4-dimethyl-6-tert-butylphenol, 4,4-dihydroxydiphenyl, and tris(2-methyl-4-hydroxy-5-tert-butylphenyl)butane; phosphite-based antioxidants; and thioether-based antioxidants. Among these, the phenol-based antioxidants and the phosphite-based antioxidants are particularly preferred. As the blowing agent, Expancel is preferred.

The resin composition of the present invention may be manufactured by melt kneading the aforesaid resins (a) and (b), and component (c), and optionally other components as required, in a single-screw extruder, a twin-screw extruder, rolls, a Bumbery's mixer, or various kneaders, at a kneading temperature of from 170 to 220° C.

The resin composition thus obtained can be used preferably as a material for a container for an aqueous liquid, an oily liquid, or a gel-like liquid, such as an ink for writing instruments such as ballpoint pens, marking pens, and writing blushes and for cosmetics such as nail enamel, gloss, and eyeliner.

### EXAMPLES

The present invention will be explained with reference to the Examples and the Comparative Examples, but not limited thereto. The evaluation methods and materials used in the Examples and the Comparative Examples are as follows.

Evaluation Methods

(1) Specific gravity: determined according to JIS K 7112 on a press sheet specimen with a thickness of 1 mm.
(2) Flexural modulus: determined according to JIS K 7171 on a standard specimen with a length of 80.0±2.0 mm, a width of 10.0±0.2 mm and a thickness of 4.0±0.2 mm.
(3) Injection molding property: a sheet of 13.5×13.5×2 mm was molded using an injection molding machine with a clamping pressure of 120 tons in the following conditions; molding temperature, 220° C.; mold temperature, 40° C.; injection rate, 55 mm/second; injection pressure, 600 kg/cm²; pressure keeping pressure, 400 kg/cm²; injection time, 6 seconds; and cooling time, 45 seconds. The sheet was evaluated for delamination, surface exfoliation, deformation, and flowmarks which extremely deteriorates visual appearance, and rated based on the following criteria.

+: Good (none of exfoliation, deformation, and conspicuous flowmark occurred)

−: Bad (exfoliation, deformation or conspicuous flowmark occurred)
(4) Extrusion molding property: a sheet of 50 mm wide×1 mm thick was extrusion molded and evaluated for drawdown properties, surface appearance and shape based on the following criteria.

+: Good (the sheet does not cause drawdown nor a fisheye on its surface and showed a good shape.)

−: Bad (the sheet causes drawdown or a fisheye on its surface or showed a bad shape.)
(5) Transparency: determined according to JIS K 7136 on a sheet specimen with a thickness of 2 mm prepared in (4) above, using a Gas Tester HGM-2DP, ex Suga Test Instruments.
(6) Steam barrier property: a cylindrical ink container with an outer diameter of 6.8 mm, an inner diameter of 5.4 mm, and a wall thickness of 0.7 mm was molded, adequately dried, charged with water by 50% of the full volume of the container, and sealed with a stopper. Then the container was allowed to stand still at a temperature of 50° C. and a relative humidity of 30% for 10 days and its weight loss in wt % from the initial weight was determined. As a control, a container molded from resin (a) alone was used to repeat the same procedures. The difference of the weight loss in wt % between the test and the control was recorded as a numerical value of the steam barrier property. The value is in minus when the weight loss in the test is less than that in the control; and in plus when the weight loss in the test is greater than that in the control. A minus value means that the container is better in the steam barrier property compared to the container molded from resin (a) alone.
(7) Oxygen barrier property: a cylindrical ink container with an outer diameter of 6.8 mm, an inner diameter of 5.4 mm, and a wall thickness of 0.7 mm was molded and adequately dried. Then the atmosphere of the container was turned to 100% oxygen and the container was provided with a sensor therein and sealed with a stopper. Then the container was allowed to stand still at a temperature of 50° C. and a relative humidity of 30% for 3 days and oxygen concentration loss in % from the initial concentration was determined by a luminescent dissolved oxygen meter. As a control, a container molded from resin (a) alone was used to repeat the same procedures. The difference of the oxygen concentration loss in % between the test and the control was recorded as a numerical value of the oxygen barrier property. The value is in minus when the concentration loss in the test is less than that in the control; and in plus when concentration loss in the test is greater than that in the control. A minus value means that the container is better in the oxygen barrier property compared to the container molded from resin (a) alone.
(8) Water and/or oil repellency: cylindrical ink containers, with an outer diameter of 6.8 mm, an inner diameter of 5.4 mm, and wall thickness of 0.7 mm were molded, adequately dried, charged with each one of liquids 1-4 indicated in Table 1 up to 50% of their full volume, and sealed with a stopper. Then the containers were allowed to stand still at a temperature of 60 degrees C. and a relative humidity of 30%, and then moved to a space at a temperature of 25 degrees C. and a relative humidity of 60%. After the liquid content adapted itself to the circumstance, the container was turned upside down to observe how the liquid content ran down on the wall and evaluated based on the following criteria.

+: a liquid content moves fast and does not adhere to the wall.

±: a small amount of a liquid content remains on the wall.

−: a liquid content remains on the wall and the volume of the liquid is difficult to confirm from outside.
(9) Evaluation of the performance of writing instruments of specs A to C and cosmetic of spec D.
   Spec A: Writing Instrument with an Aqueous Ink

A cylindrical ink container with an outer diameter of 9.2 mm and an inner diameter of 7.1 mm was molded, equipped with an ink holder made of a resin composition, and charged with liquid content 1. An aqueous ballpoint pen was made by equipping a tip of the container, via a joint member, with a ballpoint pen tip comprising a metal ball made of cemented carbide and a stainless steel holder.

The members used in the aqueous ink ballpoint pen UB-150 Black, ex Mitsubishi Pencil Co., Ltd. with a ball diameter of 0.5 mm were used except the aforementioned ink container.

Spec B: Writing Instrument with an Aqueous Gel Ink

A cylindrical ink container with an outer diameter of 5.5 mm and an inner diameter of 4.0 mm was molded and charged with liquid content 2. A gel ink ballpoint pen was made by equipping a tip of the container, via a joint member, with a ballpoint pen tip comprising a metal ball made of cemented carbide and a stainless steel holder.

Here, the members used in the aqueous gel ink ballpoint pen UM-100 Black, ex Mitsubishi Pencil Co., Ltd. with a ball diameter of 0.5 mm were used except the aforementioned ink container.

Spec C: Writing Instrument using an Oily Ink

A cylindrical ink container with an outer diameter of 3.0 mm and an inner diameter of 1.6 mm was molded, charged with liquid content 3. An oily ink ballpoint pen was made by equipping a tip of the container with a ballpoint pen tip comprising a metal ball made of cemented carbide and a stainless steel holder.

The members used in the oily ink ballpoint pen SA-G Black with a ball diameter of 0.7 mm, ex Mitsubishi Pencil Co., Ltd. were used except the aforementioned ink container.

Spec D: Nail Enamel Contained in a Container

A threaded cylindrical container with an outer diameter of 15 mm and an inner diameter of 14.5 mm was molded. The aforesaid container was joined with a threaded cap member with a coating blush to form a receptacle for a cosmetic. The cosmetic receptacle was charged with liquid content 4 to provide a nail enamel.

(9-1) Evaluation of Visibility of a Liquid Content

Pens of Specs A to C were used to draw a line of about 500 m long. Then any adhesion of the ink to the inner wall of the ink container, i.e. visibility of the liquid content, was visually observed to evaluate the pens based on the following criteria.

+: no ink adhesion occurs and a volume of the remaining ink in the container can be clearly confirmed.

±: some ink adhesion occurs, but a volume of the remaining ink in the container can be confirmed.

−: the liquid content adheres too heavily to confirm a volume of the remaining ink in the container.

The nail enamel of Spec D was shaken up and down and allowed to stand still to evaluate adhesion of the cosmetic.

+: the liquid cosmetic moves fast and does not adhere.

±: a small amount of the liquid cosmetic remains on the wall.

−: the liquid cosmetic remains on the wall so that a volume of the remaining liquid is difficult to confirm.

(9-2) Evaluation of the Performance after Stored at a High Temperature (Change Over Time at a High Temperature)

Pens of Specs A to C were stored at 60° C. and a relative humidity of 30% for three months and then a circle with a diameter of 5 cm was drawn with them to evaluate their writing properties.

+: writing was as smooth as before stored.

±: outflow of the ink decreased slightly.

−: outflow of the ink decreased so much that the writing did not progress smoothly.

Then the nail enamel of Spec D was stored at a temperature of 60° C. and a relative humidity of 30% for three months and applied on nails to evaluate the coating performance.

+: coating was as smooth as before started.

±: slightly uneven coating occurred.

−: much uneven coating occurred and normal coating was impossible.

Raw Materials for the Resin Compositions

Polypropylene resin (a): MA3H(PP), trademark, ex company Nippon Polypropylene, propylene homopolymer with peak top melting point by DSC of 163° C.; MFR at 190° C. and 2.16 kg load of 10 dg/minute, specific gravity of 0.90; and flexural modulus of 2000 MPa.
Hydrogenated terpene resin (b-1): Clearlon P-125, trademark, ex Yasuhara Chemical Co., Ltd. with a softening point of 125° C. and a glass transition point of 68° C.
Hydrogenated petroleum resin (b-2): I-MARV P-140, trademark, ex Idemitsu Petrochemical Co., Ltd., with a softening point of 140° C., an average molecular weight of 910; and a density of 1.03.
Silicone oil (c-1): SH550, trademark, ex Dow Corning Toray Silicone Co., Ltd., methylphenylsilicone oil with a viscosity at 25° C. of 125 cSt and a specific gravity of 1.07.
Fluorosurfactant (c-2): EF-102, trademark, ex Jemco Inc., anionic surfactant with a specific gravity of 2.05 and a melting point of at least 280° C.
Paraffin oil (c-3): PW-90, trademark, ex Idemitsu Petrolchemical Co., Ltd., paraffin oil.

Compositions of Liquid Contents 1 to 4

TABLE 1

| | | Liquid Content | | | |
|---|---|---|---|---|---|
| | | 1 | 2 | 3 | 4 |
| Coloring agent | MA-100 *1 | 8 | 8 | | |
| | Spilon Black GMH *2 | | | 20 | |
| | Spilon yellow C-GNH *2 | | | 5 | |
| | Spilon Violet C-RH *2 | | | 15 | |
| | Red No. 226 | | | | 0.1 |
| | CR-50 *3 | | | | 4.9 |
| Resin | Styrene acrylic acid | 3 | 3 | | |
| | resin ammonium salt | | | | |
| | Acrylic acid copolymer | | | | 27 |
| | Jurimer AT960P *4 | | | | 3 |
| pH adjusting | Aminomethylpropanol | 0.2 | 0.2 | | |
| agent | 25% aqueous ammonia | | | | 1 |
| Antiseptics | Proxel BDN *5 | 0.1 | 0.1 | | |
| Antirusting | Benzotriazole | 0.1 | 0.1 | | |
| agent | | | | | |
| Lubricant | Oleic acid | | | 5 | |
| Surfactant | Scorerol *6 | 0.1 | 0.1 | | |
| Thickening | Xanthan gum *7 | | 0.3 | | |
| agent | PVP K-15 *8 | | | 15 | |
| | BENTON EW *9 | | | | 5 |
| Vehicle | Glycerin | 5 | 5 | | |
| | Propylene glycol | 6 | 6 | | |
| | Diethylene glycol | 6 | 6 | | |
| | Purified water | 71.5 | 71.2 | | 49 |
| | Benzylalcohol | | | 7 | |
| | 2-Phenoxyethanol | | | 33 | |
| | Isopropyl alcohol | | | | 5 |
| | Ethanol | | | | 5 |

| | | | | |
|---|---|---|---|---|
| Total in part by weight | 100 | 100 | 100 | 100 |

*1 Carbon black, ex Mitsubishi Chemical
*2 Dye, ex Hodogaya Chemical Co., Ltd.
*3 Titanium oxide, ex Isihara Sangyo Kaisha Ltd.
*4 Styrene acrylic acid copolymer, ex Nippon Junyaku Co., Ltd.
*5 1,2-benzisothiazolin-3-one, ex Zeneca
*6 Non-ionic surfactant, ex Kao Corporation
*7 Kelzan AR, ex Sansho
*8 Polyvinylpyrrolidone, ex ISP
*9 Bentonite, ex National Read

### Examples 1 to 10 and Comparative Examples 1 to 9

Components indicated in Tables 2 and 3 were melt kneaded in a twin-screw kneader at a temperature of from 200 to 220° C. to prepare resin compositions of Examples 1 to 10 and Comparative Examples 1 to 9. The above-described evaluation tests (1) to (8) were carried out on the resulting compositions. The results are shown in Tables 2 and 3.

TABLE 2
(Compoisition: part by weight)

| | | | Example | | | | | | | | | |
|---|---|---|---|---|---|---|---|---|---|---|---|---|
| | | | 1 | 2 | 3 | 4 | 5 | 6 | 7 | 8 | 9 | 10 |
| Composition | (a) Polypropylene | | 100 | 100 | 100 | 100 | 100 | 100 | 100 | 100 | 100 | 100 |
| | (b-1) Hydrogenated terpene resin | | 20 | 20 | 20 | | | | 20 | 20 | 15 | 30 |
| | (b-2) Hydrogenated petroleum resin | | | | | 20 | 20 | 20 | | | | |
| | (c-1) Silicone oil | | 1 | | | 1 | | | 2 | 3 | 1 | 1 |
| | (c-2) Fluorusurfactant | | | 1 | | | 1 | | | | | |
| | (c-3) Paraffin oil | | | | 3 | | | 3 | | | | |
| Evaluation | Specific gravity | | 0.9 | 0.9 | 0.9 | 0.9 | 0.9 | 0.9 | 0.9 | 0.9 | 0.9 | 0.9 |
| results | Flexural modulus (MPa) | | 1840 | 1850 | 1810 | 1820 | 1840 | 1810 | 1830 | 1830 | 1880 | 1810 |
| | Injection molding property | | + | + | + | + | + | + | + | + | + | + |
| | Extrusion molding property | | + | + | + | + | + | + | + | + | + | + |
| | Transparency | | 30 | 31 | 32 | 32 | 32 | 33 | 31 | 32 | 32 | 30 |
| | Steam barrier property | | −0.19 | −0.18 | −0.2 | −0.17 | −0.17 | −0.16 | −0.13 | −0.12 | −0.13 | −0.24 |
| | Oxygen barrier property | | −19.3 | −19 | −19.2 | −18.5 | −18.6 | −18.5 | −21.9 | −18.9 | −7.7 | −27.3 |
| | Water/oil repellency | Liquid Content 1 | + | + | + | + | + | + | + | + | + | + |
| | | Liquid Content 2 | + | + | + | + | + | + | + | + | + | + |
| | | Liquid Content 3 | ± | ± | ± | ± | ± | ± | + | + | + | ± |
| | | Liquid Content 4 | ± | + | ± | ± | + | ± | + | + | + | ± |

TABLE 3
(Compoisition: part by weight)

| | | | Comparative Example | | | | | | | | |
|---|---|---|---|---|---|---|---|---|---|---|---|
| | | | 1 | 2 | 3 | 4 | 5 | 6 | 7 | 8 | 9 |
| Composition | (a) Polypropylene | | 100 | 100 | 100 | 100 | 100 | 100 | 100 | 100 | 100 |
| | (b-1) Hydrogenated tarpene resin | | 20 | 20 | | 50 | 20 | 20 | | 30 | |
| | (c-1) Silicone oil | | 15 | | 1 | 1 | | | 3 | | |
| | (c-2) Fluorosurfactant | | | | | | 15 | | | | |
| | (c-3) Paraffin oil | | | | | | | 15 | | | |
| Evaluation | Specific gravity | | 0.9 | 0.9 | 0.9 | 0.9 | 0.9 | 0.9 | 0.9 | 0.9 | 0.9 |
| results | Flexural modulus (MPa) | | 1780 | 1850 | 1990 | 1560 | 1760 | 1700 | 1970 | 1710 | 1990 |
| | Injection molding property | | − | + | + | − | − | − | + | + | + |
| | Extrusion molding property | | − | + | + | − | − | − | + | + | + |
| | Transparency | | 36 | 31 | 33 | 28 | 34 | 32 | 34 | 30 | 33 |
| | Steam barrier property | | 0.46 | −0.19 | 0.16 | −0.36 | 0.56 | 0.58 | 0.29 | −0.26 | 0 |
| | Oxygen barrier property | | 4.6 | −20.7 | 2.3 | −32.5 | 5.2 | 5.9 | 2.9 | −28.2 | 0 |
| | Water/oil | Liquid Content 1 | + | − | + | − | + | + | + | − | − |
| | repellency | Liquid Content 2 | + | − | + | − | + | + | + | − | − |
| | | Liquid Content 3 | + | − | + | − | + | + | + | − | − |
| | | Liquid Content 4 | + | − | + | − | + | + | + | − | − |

As seen in Table 2, the resin compositions according to the present invention were good in the transparency, gas barrier property, and water and/or oil repellency and molding properties.

Meanwhile, as seen in Table 3, the compositions of Comparative Examples 1, 5, and 6, where the amount of (c) exceeded the upper limit of the present invention, caused heavy bleed-out and were bad in the gas barrier property and the injection molding and extrusion molding properties. The compositions of Comparative Examples 2 and 8, where the amount of (c) was below the present lower limit, were bad in the water and/or oil repellency. The compositions of Comparative Examples 3 and 7, where the amount of resin (b) was below the present lower limit, were bad in the transparency and the gas barrier property. The composition of Comparative Example 4, where the amount of resin (b) exceeded the present upper limit, was very tacky and worse in the injection molding and extrusion molding properties and poor in the water and/or oil repellency. The composition of Comparative Example 9 consisting of resin (a) alone was bad in the gas barrier property, the transparency, and the water and/or oil repellency.

### Examples 11 to 18 and Comparative Examples 10 to 16

Writing instruments or cosmetic of Specs A to D described above were manufactured using the resin compositions obtained in the aforementioned Examples and Comparative Examples and evaluated their performance according to method (9) described above. The results are shown in Tables 4 and 5.

TABLE 4

| | Example | | | | | | | |
|---|---|---|---|---|---|---|---|---|
| | 11 | 12 | 13 | 14 | 15 | 16 | 17 | 18 |
| Resin | Ex. 1 | Ex. 4 | Ex. 2 | Ex. 9 | Ex. 3 | Ex. 8 | Ex. 7 | Ex. 10 |
| compostion | | | | | | | | |
| Spec | A | A | B | B | B | C | D | D |
| Liquid | + | + | + | + | ± | + | + | ± |
| visibility | | | | | | | | |
| Change | + | + | + | + | + | + | + | + |
| over time | | | | | | | | |
| at high | | | | | | | | |
| temperature | | | | | | | | |

TABLE 5

| | Comparative Example | | | | | | |
|---|---|---|---|---|---|---|---|
| | 10 | 11 | 12 | 13 | 14 | 15 | 16 |
| Resin composition | Com. Ex. 9 | Com. Ex. 2 | Com. Ex. 9 | Com. Ex. 3 | Com. Ex. 9 | Com. Ex. 8 | Com. Ex. 9 |
| Specification | A | A | B | B | C | C | D |
| Content visibility | − | − | − | + | − | − | − |
| Change over time | − | + | − | − | − | + | − |
| at high temperature | | | | | | | |

As seen in Table 4, the writing instruments and the cosmetic of the present invention did not cause adhesion of ink or nail enamel to the inner wall of their containers, and thus had the good liquid content visibility, and the performance did not degrade after stored at a high temperature.

As seen in Table 5, the containers for the writing instruments and the cosmetic that did not have the composition of the present invention had the low water and/or oil repellency, and thus had a worse liquid content visibility, and the performance degraded after stored at a high temperature due to the poor gas barrier property. As the reason for the degraded performance, mention may be made of increase in viscosity due to evaporation of the liquid content, deterioration of the liquid content due to gas permeation through the tube container wall, and inhibited flow of the liquid content due to gas generation in the tube container.

### INDUSTRIAL APPLICABILITY

The resin composition of the present invention are good in a gas barrier property, transparency, water and/or oil repellency and, therefore, can be used advantageously for a liquid holding part of, for instance, writing instruments such as ballpoint pens and cosmetics.

1. A resin composition for a liquid container, wherein said composition comprises:
(a) 100 parts by weight of a polyolefin resin;
(b) 3 to 40 parts by weight of at least one resin selected from the group consisting of hydrogenated terpene resins, petroleum resins, and hydrogenated petroleum resins; and
(c) 0.03 to 5 parts by weight of at least one component selected from the group consisting of silicone oils, fluorosurfactants, and paraffin oils, with their viscosities being 20 to 3000 cSt at 25° C., as determined according to JIS Z 8803.

2. The resin composition according to claim 1, wherein resin (a) is at least one resin selected from the group consisting of a low density polyethylene, a linear low density polyethylene, a medium density polyethylene, a high density polyethylene, and polypropylene.

3. The resin composition according to claim 1, wherein resin (a) is at least one resin selected from the group consisting of an isotactic propylene homopolymer and a block copolymer of propylene with at least one selected from the group consisting of ethylene and α-olefins.

4. A molded container composed of the resin composition according to claim 1.

5. An ink container for a writing instrument, composed of the resin composition according to claim 1.

6. A writing instrument having the container according to claim 5.

7. A container for a cosmetic, composed of the resin composition according to claim 1.

8. A cosmetic contained in the container according to claim 7.
